(19) United States
(12) Patent Application Publication
(10) Pub. No.: US 2009/0255185 A1
(43) Pub. Date: Oct. 15, 2009

(54) DEVICE FOR THE TRANSFER OF TORQUE

(75) Inventors: Stephan Schachtl, Creitel Cedex (FR); Eric Bittner, Creitel Cedex (FR); Markus Pflueger, Creitel Cedex (FR); Armin Dietl, Creitel Cedex (FR)

Correspondence Address: OSHA LIANG L.L.P., TWO HOUSTON CENTER, 909 FANNIN, SUITE 3500, HOUSTON, TX, 77010, US

(73) Assignee: VALEO SICHERHEITSSYSTEME GMBH, Erdweg (DE)

(21) Appl. No.: 12/303,197

(22) PCT Filed: May 23, 2007
(86) PCT No.: PCT/EP07/55028

§ 371 Date: Dec. 2, 2008

(30) Foreign Application Priority Data
May 24, 2006 (DE) 10 2006 024 349.8

(51) Int. Cl. E05F 15/12

(52) U.S. Cl. 49/334

(57) ABSTRACT

The invention relates to a device (3) for the transfer of the torque of a drive output shaft (11) of a drive (1) that can be mounted on the body of a motor vehicle on the first half of a frame joint (4) of a frame joint (2) having a hinge axis (6), which first half of a frame joint (4) is attached to a vehicle lid of the motor vehicle, with the rotation axis (17) of the drive output shaft (11) and the hinge axis (6) in essence aligned with each other in mounted state of the drive (1). In order to assure a quick mounting of the drive (1) and to achieve an optimal displacement path of the vehicle lid during the closing procedure, with which the angle- and length tolerances of the drive (1) and the vehicle lid are balanced in a simple way, the invention proposes using a torque proof drive lever (9) that can be connected to the drive output shaft (11) which has a crank (16) that extends in direction of the longitudinal axis (15) of the drive lever (9), axially at a distance from the connecting region (100) of the drive lever (9) with the drive output shaft (11), in which crank (16) a sliding block (13) is arranged in a shiftable manner. This sliding block (13) forms the pivot bearing of the pivot (14) of a preferably plate-shaped adapter part (12) which can be firmly connected to the first half of the frame joint (4).

The invention relates to a device for the transfer of a torque from an output shaft of a drive that can be mounted on the body of a motor vehicle to a first hinge half of a hinge having a hinge axis, which first hinge half is attached to a vehicle gate of the motor vehicle, with the rotational axis of the output shaft and the hinge axis being arranged essentially flush with one another in the mounted state of the drive.

Such a device is known, for example, from DE 102 22 298 A1. Therein, the device comprises a drive lever which is formed in the manner of a strap and which can be connected by its first end to the output shaft of a tailgate drive in a rotationally fixed manner. The drive lever is adapted to the shape of the first hinge half (which is also referred to as a hinge strap) in terms of its shape and can be attached by its second end, which faces away from the output shaft and is formed in a flange-like manner, on the end, which faces the tailgate, of the first hinge half such that, in the mounted state of the drive, in the event of rotation of the output shaft, the drive lever arranged parallel to the hinge half is pivoted and can carry along the first hinge half and the tailgate.

In the case of the known device, the drive lever and the first hinge half are adapted to one another such that, in the event of a subsequent installation of a tailgate drive, the tailgate hinge which is already present and has to be connected to the drive cannot generally be used. Moreover, due to the tolerances of the tailgates in different vehicles and the tolerances of the dimensions of the drives, mounting problems may occur if account has not been taken of these tolerances by means of corresponding bearing plays. However, the greater the play between drive and tailgate, the higher the speed of the tailgate in front of the lock must be so that the tailgate fully closes.

The object of the invention is to indicate a device of the type cited at the outset in which a gate drive, preferably for a tailgate, can also be subsequently installed in a simple manner in a motor vehicle without the existing hinge having to be replaced. In this case, the angle and length tolerances of the drive and the vehicle gate should be balanced out in a simple manner in order to ensure that the gate drive can be mounted quickly and to achieve an optimum displacement path of the vehicle gate during the closing process.

This object is achieved as claimed in the invention by the features of claim 1. The subordinate claims disclose further, particularly advantageous configurations of the invention.

The invention is essentially based on the concept of using a drive lever which can be connected to the output shaft in a rotationally fixed manner and which, axially spaced apart from the connecting region of the output shaft, has a connecting member extending in the direction of the longitudinal axis of the drive lever, in which connecting member a sliding block is displaceably arranged. This sliding block forms the pivot bearing of the journal of a preferably plate-like adapter part which connects the drive lever to the first hinge half.

In the case of the device as claimed in the invention, the drive lever neither needs to have a strap-like shape adapted to the first hinge half, nor does the end of the drive lever have to be connected to the end of the first hinge half. Rather, the length of the drive lever, which is, for example, formed straight, depends on the location at which the adapter part is supposed to be attached expediently on the first hinge half, wherein the rotational axis of the journal runs parallel to the hinge axis. A balancing out of the tolerances of drive and tailgate is ensured by the rotatable mounting of the journal connected to the adapter part in the sliding block and the displaceability of the sliding block.

It has proved to be advantageous if the drive lever and the adapter part are formed and connected to one another in such a manner that the adapter part can be attached in the strap-like region, which adjoins the hinge axis, of the first hinge half.

The play which occurs between drive and tailgate during their intended use is significantly reduced in comparison to known devices and the displacement path and the function are thus improved.

Moreover, in the case of subsequent fitting of a tailgate drive, the gate hinge which is already present can generally still be used. The only requirement is that a bore hole is made in this hinge half to connect the first hinge half to the adapter part such that the adapter part can be attached in a non-positive manner to the first hinge half, for example, by means of a screw.

The output shaft of the drive and the drive lever can be connected to one another by means of a positive or non-positive connection. It has proved to be particularly advantageous if, in the event of a positive connection, a spline shaft connection is used.

Further details and advantages of the invention will become apparent from the following exemplary embodiments explained with reference to figures. In these figures:

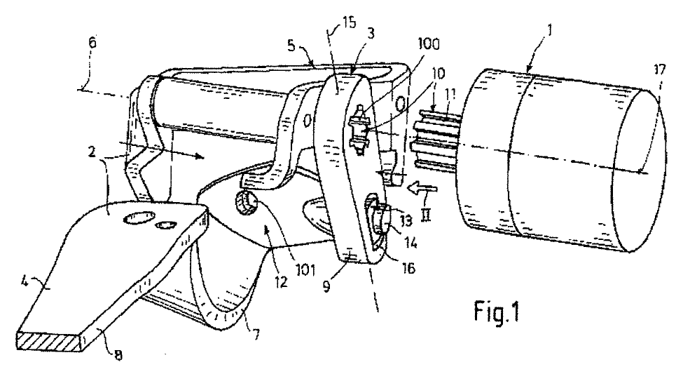

FIG. 1 shows a perspective representation of a device as claimed in the invention, which is connected to the first hinge half of a tailgate hinge, as well as a drive with an output shaft prior to connection of the output shaft to a drive lever of the device as claimed in the invention and

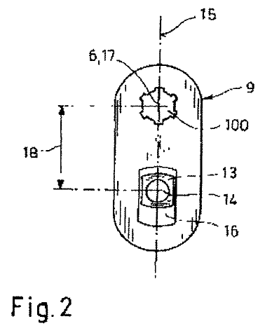

FIG. 2 shows a side view of the drive lever shown in FIG. 1 from the side designated by II in FIG. 1.

In FIG. 1, 1 designates a tailgate drive which is known per se, 2 designates a hinge which is known per se and 3 designates a device as claimed in the invention.

Hinge 2 comprises two hinge halves 4, 5 which are connected to one another via a hinge pin, not shown, and are pivotable relative to one another about a hinge axis 6. First hinge half 4 has a strap-like region 7 and a straight flange-like region 8 which serves to connect first hinge half 4 to the tailgate, not shown, of a motor vehicle, also not shown.

Second hinge half 5 can be connected at the roof support to the body of the motor vehicle, not shown.

Device 3 as claimed in the invention essentially encompasses a drive lever 9 which can be connected to output shaft 11 of drive 1 in a rotationally fixed manner via a spline shaft connection 10 and a plate-like adapter part 12 connected to drive lever 9, which adapter part 12 can be connected to first hinge half 4 in a rotationally fixed manner, for example, via a screw connection (FIG. 1 shows only the bore holes designated by 101 for the screw connection).

As is apparent from FIG. 1, drive lever 9 and adapter part 12 are formed and connected to one another such that adapter part 12 is attached in strap-like region 7, which adjoins hinge axis 6, of first hinge half 4.

The connection between drive lever 9 and adapter part 12 is performed by means of a sliding block 13 in which a journal 14 arranged at the end of adapter part 12 is rotatably mounted. Sliding block 13 is displaceably arranged in a connecting member (longitudinal hole) 16 extending in the direction of longitudinal axis 15 (FIG. 2) of drive lever 9. In this case, adapter part 12 and sliding block 13 are secured against falling out of connecting member 16 by parts, not shown (e.g. a disc arranged on the journal or a split-pin or the like).

If tailgate drive 1 and hinge 2 are connected via device 3 as claimed in the invention and output shaft 11 of drive 1 now rotates, due to the positive connection of output shaft 11 and drive lever 9, drive lever 9 also rotates around rotational axis 17 of output shaft 11 and thus also about hinge axis 6 whose position essentially corresponds to rotational axis 17. As a result, journal 14 of adapter part 12 mounted in sliding block 13 at an axial distance 18 from rotational axis 17 is also pivoted and thus also first hinge half 4 connected to the tailgate.

Since drive lever 9 is both pivotable about journal 14 of adapter part 12 and, due to connecting member 16, is displaceable in the direction of its longitudinal axis 15, tolerances between the position of drive 1 (or of drive shaft 11) and the tailgate (or first hinge half 4) are balanced out.

### LIST OF REFERENCE NUMBERS

1 Tailgate drive, drive

2 Hinge

3 Device as claimed in the invention

4 First hinge half

5 Second hinge half

6 Hinge axis

7 Strap-like region

8 Flange-like region

9 Drive lever

10 Spline shaft connection

11 Output shaft

12 Adapter part

13 Sliding block

14 Journal

15 Longitudinal axis

16 Connecting member

17 Rotational axis

18 Distance

100 Connecting region

101 Bore hole

1. A device for the transfer of a torque from an output shaft of a drive mounted on the body of a motor vehicle to a first hinge half of a hinge having a hinge axis, wherein the first hinge half is attached to a vehicle gate of the motor vehicle, with a rotational axis of the output shaft and the hinge axis arranged flush with one another in the mounted state of the drive, the device comprising:
a drive lever connected to the output shaft of the drive in a connecting region in a rotationally fixed manner;
a connecting member on the drive lever which is axially spaced apart and extends from the connecting region of the drive lever in the direction of the longitudinal axis of the drive lever, wherein the connecting member comprises a sliding block that is displaceably arranged; and
an adapter part which, on the one hand, connected to the first hinge half of the hinge in a rotationally fixed manner and which, on the other hand, is provided with a journal which is rotatably mounted in the sliding block.

2. The device as claimed in claim 1, wherein the output shaft of the drive and the drive lever are connected to one another via a positive connection.

3. The device as claimed in claim 2, wherein the positive connection is a spline shaft connection.

4. The device as claimed in claim 1, wherein the adapter part is formed plate-like on its side facing the first hinge half.

5. The device as claimed in claim 1, wherein the adapter part is attached to the first hinge half by means of a screw connection.

6. The device as claimed in claim 1, wherein the drive lever and the adapter part are formed and connected to one another such that the adapter part is attached in the strap-like region, which adjoins the hinge axis, of the first hinge half.
